(19) United States
(12) Patent Application Publication
(10) Pub. No.: US 2006/0068816 A1
(43) Pub. Date: Mar. 30, 2006

(54) Network based contacts with optional DTMF exchange of the same

(75) Inventors: Mariana Benitez Pelaez, Boston, MA (US); Charu Verma, Darien, IL (US); Kamal K. Verma, Darien, IL (US)

Correspondence Address: Richard J. Minnich, Esq.;Fay, Sharpe, Fagan, Minnich & McKee, LLP, 1100 Superior Avenue, Seventh Floor, Cleveland, OH, 44114-2518, US

(73) Assignee: Lucent Technologies Inc.

(21) Appl. No.: 10/954,450

(22) Filed: Sep. 30, 2004

(51) Int. Cl. H04M 3/42; H04Q 7/20

(52) U.S. Cl. 455/466; 455/419

(57) ABSTRACT

A method is provided for managing contact information for a wireless mobile terminal (40) having an electronic directory that stores contacts thereon along with the telephone numbers for the contacts. The method includes: maintaining a database (70) containing contact information for a user of the terminal (40), the contact information including a list of the user's contacts along with telephone numbers for the contacts, the database (70) being accessible by an application server (24) associated with a wireless telecommunications network (10) serving the terminal (40); providing a network-based contact feature administer by the application server (24) for accessing the user's contact information on the database (70); establishing a connection over the network (10) between the terminal (40) and the application server (24); and, processing contact information in accordance with a selected operation.

### FIELD

The present inventive subject matter relates to the art of telecommunications. It finds particular application in conjunction with an IMS (Internet Protocol (IP) Multimedia Subsystem), and will be described with particular reference thereto. However, it is to be appreciated that the inventive subject matter is also amenable to other like applications and suited to other similar communication networks or environments.

### BACKGROUND

Known end user communication devices in the telecommunications field, commonly referred to as user equipment, terminals, user agents, etc., are often equipped to handle various types of different tasks, for example, to complement and/or enhance communication functions. To aid dialing without having to remember telephone numbers, a Mobile Station (MS) (e.g., a mobile telephone, wireless personal digital assistant (PDA), wireless equipped portable or laptop computer, etc.) is often provisioned with a Electronic Directory (ED) into which a user selectively programs or otherwise stores desired telephone numbers and other-contact information, e.g., names, addresses, etc. Various such EDs and their implementations are commonly known. Typically, the stored telephone numbers can be dialed by selecting the desired contact from the ED. Entry of information into the ED, however, can be cumbersome and time consuming, especially in the case of mobile telephones and PDAs which can have limited data input devices as compared to a full keyboard. For example, in a mobile telephone, information is commonly entered into the ED using the mobile telephone's keypad, typically containing only twelve keys (i.e., keys 0-9, an asterisk key, and a pound key). Accordingly, entering different letters and/or other non-numeric text often involves carrying out various combinations of multiple keystrokes for each character to be entered.

There are drawbacks, at times, to having the ED stored only on the MS. For example, an undesirable situation may arises when a user or mobile subscriber changes their MS, such as when they purchases a new mobile telephone. It may be difficult to readily transfer the contact information from the ED in the old MS into the new MS. One approach to achieving this goal involves the direct connection of the two devices, e.g., through a cable or other data transfer interface. This approach, however, can be undesirable insomuch as there are costs associated with providing and/or purchasing the additional cable or interface equipment, and it may be inconvenience at the time the transfer is desired to have both device together. Additionally, such a transfer is likely not possible if the new MS is being purchased because the old MS is lost or damaged. The option of manually re-entering the contact information into the ED of the new MS, as discussed above, may be undesirably time consuming and/or burdensome.

Yet another situation may arise, e.g., when two users or mobile subscribers are talking to one another and they desire to transfer contact information between one another. While the calling party's telephone number may be captured by the called party's caller-ID, the prior art does not provide an easy way to transfer other contact information from the ED of one MS to the other while the call is active. Additionally, Bluetooth and/or Infrared technologies have been developed which could support such a transfer, however, the two devices would have to be in relatively close proximity to one another, which may not be the case at the time the transfer is desired.

A new and improved telecommunications method and/or system is disclosed that overcomes the above-referenced problems and others.

### SUMMARY

In accordance with one embodiment, a method is provided for managing contact information for a wireless mobile terminal having an electronic directory that stores contacts thereon along with the telephone numbers for the contacts. The method includes: maintaining a database containing contact information for a user of the terminal, the contact information including a list of the user's contacts along with telephone numbers for the contacts, the database being accessible by an application server associated with a wireless telecommunications network serving the terminal; providing a network-based contact feature administer by the application server for accessing the user's contact information on the database; establishing a connection over the network between the terminal and the application server; and, processing contact information in accordance with a selected operation.

In accordance with another embodiment, a system is provided for managing contact information for a wireless mobile terminal having an electronic directory that stores contacts thereon along with the telephone numbers for the contacts. The system includes: a database containing contact information for a user of the terminal, the contact information including a list of the user's contacts along with telephone numbers for the contacts, the database being accessible by an application server associated with a wireless telecommunications network serving the terminal; means for providing a network-based contact feature administer by the application server for accessing the user's contact information on the database; means for establishing a connection over the network between the terminal and the application server; and, means for processing contact information in accordance with a selected operation.

In accordance with yet another embodiment, a method is provided for transferring contact information over a wireless telecommunications network. The method includes: establishing a call over the network between a first mobile terminal and a second mobile terminal, each terminal having an electronic directory that stores contact information therein including contacts along with associated telephone numbers for the contacts; providing a contact exchange feature for transferring contact information between the terminals while maintaining the established call; receiving a signal from the first terminal invoking the feature; and, transferring contact information from the first terminal to the second terminal over the network.

Numerous advantages and benefits of the inventive subject matter disclosed herein will become apparent to those of ordinary skill in the art upon reading and understanding the present specification.

### BRIEF DESCRIPTION OF THE DRAWINGS

The present inventive subject matter may take form in various components and arrangements of components, and in various steps and arrangements of steps. The drawings are only for purposes of illustrating example embodiments and are not to be construed as limiting. Further, it is to be appreciated that the drawings are not to scale.

FIG. 1 is a diagrammatic illustration showing an exemplary telecommunications environment suitable for practicing aspects of the present inventive subject matter.

FIG. 2 is a flow chart illustrating an exemplary process for a network-based contact feature supported by the network of FIG. 1.

FIG. 3 is a flow chart illustrating an exemplary process for a contact information exchange feature supported by the network of FIG. 1.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components and features that are commonly known in the telecommunications art without further detailed explanation as to their configuration or operation except to the extent they have been modified or altered in accordance with and/or to accommodate the embodiment(s) presented herein. Additionally, the following acronyms shall be used in the present specification:

3G—3^{rd} Generation

3GPP—3^{rd} Generation Partnership Project

3GPP2—3^{rd} Generation Partnership Project 2

AAA—Authentication/Authorization/Accounting

AH—Address Handling

AS—Application Server

BGCF—Border Gateway Control Function

CCF—Call Control Function

CDMA—Code Division Multiple Access

CIEF—Contact Information Exchange Feature

CSCF—Call Session Control Function

DTMF—Dual Tone Multi-Frequency

ED—Electronic Directory

HLR—Home Location Register

HSS—Home Subscriber Server

ICGW—Incoming Call Gateway

IMS—IP Multimedia Subsystem

IP—Internet Protocol

MGCF—Media Gateway Control Function

MGW—Media Gateway

MMT—Multimedia Terminal

MRFC—Multimedia Resource Function Controller

MRFP—Multimedia Resource Function Processor

MS—Mobile Station

NBCF—Network-Based Contact Feature

PDA—Personal Digital Assistant

PDN—Public Data Network

PLMN—Public Land Mobile Network

PSDN—Packet Switched Data Network

PSTN—Public Switched Telephone Network

RAN—Radio Access Network

SIP—Session Initiation Protocol

SMS—Short Message Service

SPD—Serving Profile Database

UMTS—Universal Mobile Telecommunications System

URI—Universal Resource Identifier

VoIP—Voice over IP

WLAN—Wireless Local Area Network

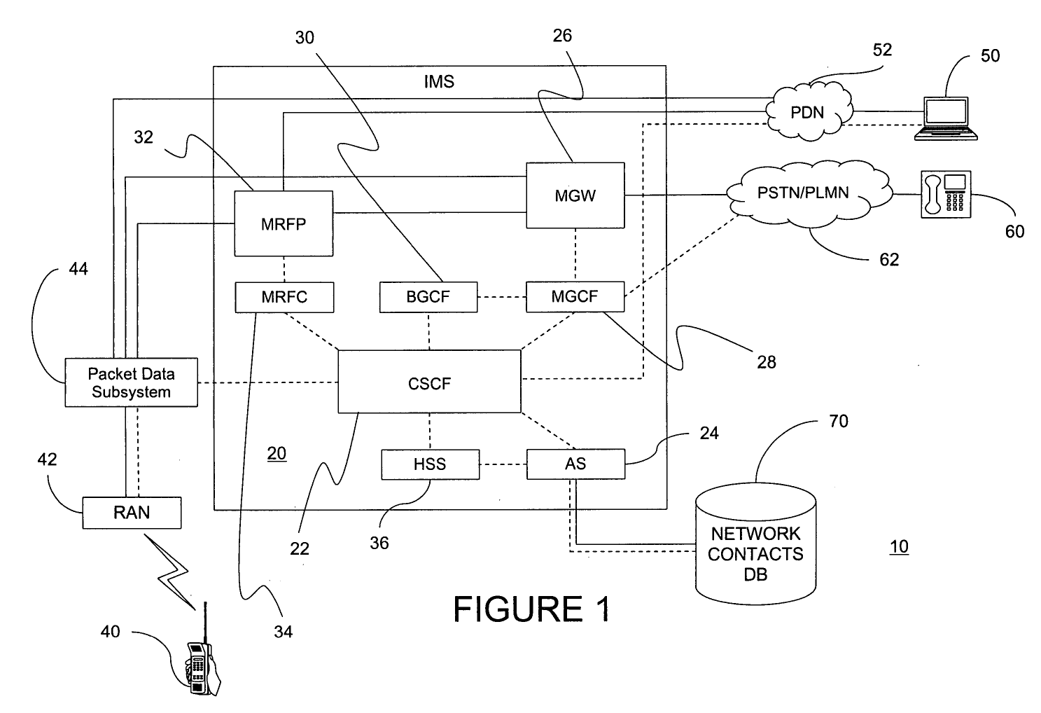

With reference to FIG. 1, an optionally 3GPP/3GPP2 compliant telecommunications environment or network 10 is equipped and/or arranged to manage and/or route communications between terminals. Other suitable telecommunications environments, however, may be employed. The network 10 includes an IMS 20 that incorporates in the usual manner a number of network entities and/or elements, namely, one or more of a CSCF 22, AS 24, MGW 26, MGCF 28, BGCF 30, MRFP 32, MRFC 34, HSS 36. As is known in the art, the IMS 20 manages call sessions and provides and administers packet switching for multimedia communications within the network 10.

For exemplary purposes, a MS 40 (nominally the first terminal) is shown operatively connected to the IMS 20 via a RAN 42. The RAN 42, as it is known, is that portion of a mobile network that handles subscriber access, including radio base stations and control and concentration nodes, i.e., the portion relating to “over the air” communications between the mobile terminal and the network base station. A packet data subsystem 44 interfaces the RAN 42 with the IMS 20 and PDN 52 in the usual manner.

Another end user terminal 50 (nominally the second terminal) is shown as a laptop or notebook type computer operatively connected to the IMS 20 via a PDN 52. The second terminal 50 optionally employs a WLAN or wire line, in the usual manner, to operatively connect to the PDN 52.

End user terminal 60 (nominally the third terminal) is shown as an ordinary telephone equipped to handle voice communications. The third terminal 60 is operatively connected to the IMS 20 via a PSTN/PLMN 62.

Only a single first, second and third terminal are shown in FIG. 1 for the purpose of simplicity herein. However, it is to be appreciated that typically a plurality of such terminals are similarly situated. Additionally, while depicted as specific types of end-user terminals, other like terminals are also contemplated.

With continuing reference to FIG. 1, the bearer paths, as are known in the art, that carry and/or relay the communication traffic and/or user information intended to be transmitted from one terminal to another are shown as solid lines. Control paths, as are known in the art, carry and/or relay associated signaling and/or control commands or messages to and between appropriate network elements and/or entities such that call sessions are properly managed and routed. The control paths are shown as dashed lines in FIG. 1. Suitably, SIP and/or other appropriate known protocols are used on the control and bearer paths, respectively, e.g., the known H.248 protocol is suitably employed for media gateway controls. The CSCF 22, BGCF 30, MGCF 28, MRFC 34 and AS 24 comprise the call control and signaling functionality for the IMS 20, while the bearer paths interface with the MRFP 32 and MGW 26 to provide and support interconnectivity to external networks and/or subsystems, such as, the packet data subsystem 44, PDN 52 and PSTN/PLMN 62. Optionally, the AS 24 may also have an embedded or be otherwise equipped with MRFP 32 function to provide for bearer path connectivity.

The CSCF 22 supports and controls multimedia sessions. The CSCF 22 invites the MGCF 28 and/or MRFC 34 to call sessions to control the establishment and maintenance of bearer paths for call sessions, e.g., by adding, modifying or deleting appropriate bearer paths for respective call sessions. The CSCF 22 is the signaling entity for call session control. It manages sessions (e.g., using SIP and/or other appropriate call/session establishment protocols), provides features and services and coordinates with other network elements for session control, service control and resource allocation. The functions performed by the CSCF 22 are Incoming Call Gateway (ICGW), Call Control Function (CCF), Serving Profile Database (SPD) and Address Handling (AH).

The ICGW function acts as a call session entry point and routes incoming calls.

The CCF executes call setup/termination and state/event management. It interacts with the MGCF 28 for calls to/from the PSTN/PLMN 62, and with the BGCF 30 for calls to the PSTN/PLMN 62 to determine the appropriate MGCF 28 to use. It also controls the MRFP 32 via the MRFC 34 (which interprets information or signals coming from the CSCF 22 and controls the MFRP 32 accordingly) in order to support conferencing and other multi-party services. SIP level registrations from subscribers are processed in CCF. The CCF may provide service trigger mechanisms to the AS 24 to invoke services provided thereby (either locally, at the AS 24, or elsewhere). It also reports call events for billing, auditing, intercept or other purposes, and may query the AH function to check whether a requested communication is allowed given the current subscription.

The SPD function interacts with the HSS 36 to receive and cache user profile information, and the AH function performs address handling, including address analysis, translation, modification (when appropriate) and mapping.

The MGW 26 acts as a bearer path interface between the IMS 20 and externals networks and/or subsystems, and provides translation resources and resources for modifying the bearer stream (e.g., encoding, transcoding, compression, packetization, depacketization, etc.). It interacts with the MGCF 28 (which interprets signaling coming from the CSCF 22 and controls the MGW 26 accordingly) in order to achieve resource allocation, bearer path control, and payload processing. The MGCF 28 communicates with the CSCF 22 in order to control the call state for media channels on one or more MGWs and performs conversions between legacy and 3G UMTS/CDMA network call control protocols. Similarly, the MRFC 34 controls the media stream resources in the MRFP 32 which also acts as a bearer path interface between the IMS 20 and external networks and/or subsystems, however, being able to provide for conferencing or multiple party communications or other more advanced media services (relative to the MGW 26).

The HSS 36 maintains subscriber and system related data, user profiles, locations, etc. Optionally, the HSS 36 also contains what is known as the HLR functionality and/or AAA function. Suitably, the HSS database includes: user identification, via numbering and addressing information; user security information, including network access control information for authentication and authorization; user location information for user registration and locating; and a user profile, including identification of the services subscribed to and other service specific information.

Suitably, the AS 24 provides a Network-Based Contact Feature (NBCF) to mobile users subscribing to the feature. Prior to granting access to the NBCF, optionally, the HSS 36 is queried or otherwise checked to see if the appropriate subscription is held by the user. Accordingly, if the proper subscription is held, access is granted, and if not, access is denied.

The NBCF allows contact information conventionally stored in the ED of the MS 40 to also be maintained at the network level. For example, contact information for each mobile user subscribing to the feature is stored in a network contact database (DB) 70 accessible by or part of the AS 24 administering the NBCF.

Suitably, the NBCF provides various functions to mobile subscribers for managing and using contact information. For example, the contact information in the DB 70 and the ED of the MS 40 may be selectively synchronized, contact information may selectively uploaded from the MS 40 to the DB 70 or alternately downloaded from the DB 70 into the ED of the MS 40, or calls may be placed to contact telephone numbers stored in the DB 70.

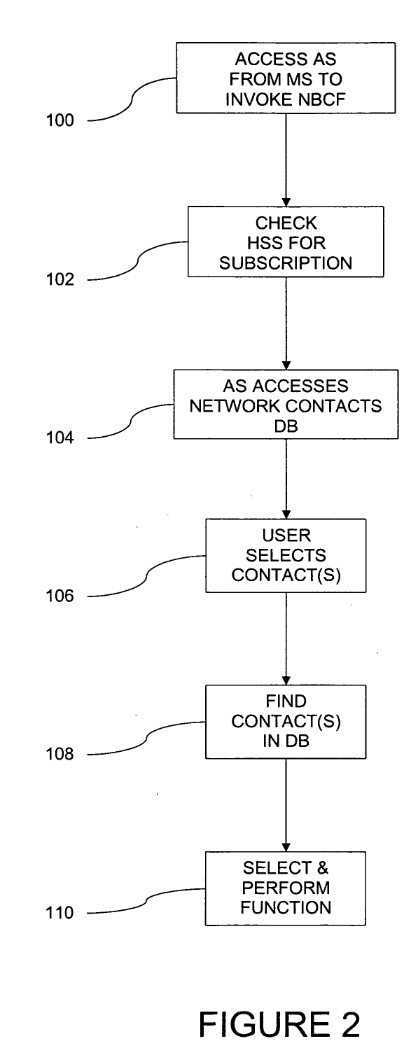

With reference to FIG. 2, an exemplary process for implementing the NBCF is shown. At step 100, a user employs the MS 40 to access the AS 40 and employ the NBCF administered thereby. For example, the user may initiate the process by selecting a designated item from a menu presented on the MS 40, dialing a particular feature code or calling a known URI associated with the NBCF.

At step 102, the AS 40 checks the HSS for the appropriate subscription to the NBCF. If the proper subscription is held, access is granted, and if not, access is denied. Assuming the proper subscription is held and access is granted to the user, at step 104, the AS 40 accesses the DB 70 for the subscribers contact information or records stored therein. A dialog is opened, at step 106, such that the user is prompted to and/or otherwise permitted to enter one or more selected contacts. At step 108, the corresponding contacts are found in the DB 70.

At step 110, the user selects a desired function to be preformed with the identified contacts. For example, if an upload function is selected, the contact information for the selected contact(s) is transferred from the ED of the MS 40 to the DB 70. Alternately, if a download function is selected, the contact information for the selected contact(s) is transferred from the DB 70 to the ED of the MS 40. If a call function is selected, then a call is initiated (optionally, by the network) to the telephone number stored in the DB 70 for the selected contact. In the case where the call function is selected and multiple contacts are selected, a conference or three-way call is optionally set-up to all the associated telephone numbers obtained from the DB 70.

It is to be appreciated, in the case where synchronization is desired; a user may simply select all the contacts for uploading or downloading as desired. Alternately, modifications to contact entries are time stamped to indicate when they were last changed such that a synchronize function may be implemented which automatically determines (based upon when a contact entry or record was last changed and when synchronization was last preformed) which contact record are to be uploaded from the MS 40 to the DB 70 and which are to be downloaded from the DB 70 to the MS 40.

Optionally, a user is also able to update or otherwise manage their network-based contacts through a webpage or website accessed, e.g., via the MS 40 or another terminal, such as the terminal 50. By logging onto the webpage or website, the user is granted access to their contact information on the DB 70 such that they are able to change, add, delete or otherwise edit their respective contact information.

In one embodiment, the IMS 20 establishes a suitable bearer path between the end user terminal (e.g., MS 40) and the DB 70 such that transferred contact information is routed appropriately along the established bear path in the appropriate direction for the function selected. Alternately, via suitable signaling, the contact information is exchanged between the two along a control channel or path.

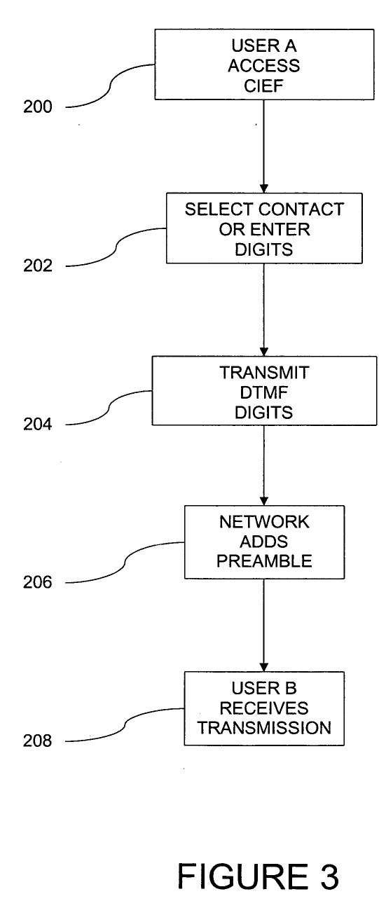

With reference to FIG. 3, optionally, a Contact Information Exchange Feature (CIEF) is also supported. The CIEF allows contact information to be exchanged between different users. Suitably, the contact information can be exchanged while the users on a call with one another.

Consider, for example, a user A and a user B each employing an end user terminal (such as MS 40) to conduct a call with one another. At step 200, user A invokes the CIEF with their terminal, e.g., by selecting a designated item from a menu presented on the terminal. At step 202, user A then select a third party's contact information to exchange or transfer to user B's terminal. Optionally, the contact is selected from the ED on user A's terminal. Alternately, the contact may be accessed from user A's contact information on the DB 70. Alternately, user A may simply dial the telephone number to be transferred to user B.

At step 204, the contact information (i.e., telephone number) selected is transmitted to user B's terminal, e.g., in band with the bearer path set-up there between. Suitably, the telephone number is transmitted as DTMF digits. At step 206, as the contact information traverses the IMS 20, the network adds a known preamble or identifier to the message transmitted. The preamble appropriately identifies the transmission as contact information being sent from user A. At step 208, user's B terminal receives the transmitted contact information. Suitably, user B's terminal recognizes the preamble or identifier and then interprets the received transmission as the telephone number or contact information sent from user A. The contact information is then store in the ED on user B's terminal.

Again, optionally, the CIEF is a subscription feature. Accordingly, the HSS 36 is optionally queried to determine if one or both of the users exchanging contact information hold the subscription to the feature before permitting access to the feature. Additionally, the receiving user may opt to have the network capture the incoming data and direct it to their contact information to be stored in the DB 70. Suitably, the receiving user may also set preferences so that the contact information is captured by the network and sent to user B via SMS, e-mail, etc., as desired. Likewise, in the case that the call between users A and B were a voice/text call the network could interpret the DTMF digits and convey them to user B in the form of a text message or send it via e-mail, etc.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of managing contact information for a wireless mobile terminal having an electronic directory that stores contacts thereon along with the telephone numbers for the contacts, said method comprising:
(a) maintaining a database containing contact information for a user of the terminal, said contact information including a list of the user's contacts along with telephone numbers for the contacts, said database being accessible by an application server associated with a wireless telecommunications network serving the terminal;
(b) providing a network-based contact feature administered (?) by the application server for accessing the user's contact information on the database;
(c) establishing a connection over the network between the terminal and the application server; and,
(d) processing contact information in accordance with a selected operation.

2. The method of claim 1, wherein the operation include uploading contact information such that contact information is transferred over the network from the terminal to the database.

3. The method of claim 1, wherein the operation includes downloading contact information such that contact information is transferred over the network from the database to the terminal.

4. The method of claim 1, further comprising:
maintaining a list of users that subscribe to the feature; and,
determining if a user invoking the feature subscribes to the feature before granting access thereto.

5. The method of claim 1, further comprising:
obtaining an input contact from the terminal;
identifying the contact in the database corresponding to the input contact; and,
processing the identified contact in step (d).

6. The method of claim 1, wherein a select operation includes placing a call to a contact in the database, said call being placed by the network to the telephone number associate with the contact in the database.

7. The method of claim 1, wherein a select operation includes transferring selected contact information in the database to a second terminal other than the user's terminal.

8. A system for managing contact information for a wireless mobile terminal having an electronic directory that stores contacts thereon along with the telephone numbers for the contacts, said system comprising:
a database containing contact information for a user of the terminal, said contact information including a list of the user's contacts along with telephone numbers for the contacts, said database being accessible by an application server associated with a wireless telecommunications network serving the terminal;
means for providing a network-based contact feature administer by the application server for accessing the user's contact information on the database;
means for establishing a connection over the network between the terminal and the application server; and,
means for processing contact information in accordance with a selected operation.

9. The system of claim 8, wherein the operation include uploading contact information such that contact information is transferred over the network from the terminal to the database.

10. The system of claim 8, wherein the operation includes downloading contact information such that contact information is transferred over the network from the database to the terminal.

11. The system of claim 8, further comprising:
means for maintaining a list of users that subscribe to the feature; and,
means for determining if a user invoking the feature subscribes to the feature before granting access thereto.

12. The system of claim 8, further comprising:
means for obtaining an input contact from the terminal;
means for identifying the contact in the database corresponding to the input contact; and,
means for processing the identified contact in step (d).

13. The system of claim 8, wherein a select operation includes placing a call to a contact in the database, said call being placed by the network to the telephone number associate with the contact in the database.

14. The system of claim 8, wherein a select operation includes transferring selected contact information in the database to a second terminal other than the user's terminal.

15. A method of transferring contact information over a wireless telecommunications network, said method comprising:
(a) establishing a call over the network between a first mobile terminal and a second mobile terminal, each terminal having an electronic directory that stores contact information therein including contacts along with associated telephone numbers for the contacts;
(b) providing a contact exchange feature for transferring contact information between the terminals while maintaining the established call;
(c) receiving a signal from the first terminal invoking the feature; and,
(d) transferring contact information from the first terminal to the second terminal over the network.

16. The method of claim 15, wherein the contact information is transferred as a Dual Tone Multi-Frequency transmission.

17. The method of claim 16, further comprising:
associating an identifier with the transmission, said identifier marking the transmission as contact information from the first terminal such that the second terminal recognizes the transmission as contact information from the first terminal upon receipt.

18. The method of claim 16, further comprising:
converting the transmission into a text message.

19. The method of claim 16, further comprising:
storing the transmitted contact information in a database accessible by the network.

20. The method of claim 16, wherein the transmission is carried in band with the established call along a bear path between the terminals.
